(19) United States
(12) Patent Application Publication
(10) Pub. No.: US 2003/0051539 A1
(43) Pub. Date: Mar. 20, 2003

(54) Method and apparatus for measuring valve overlap of an engine

(76) Inventor: Dal-Heun Shin, Seoul (KR)

Correspondence Address: Pennie & Edmonds, LLP, 3300 Hillview Avenue, Palo Alto, CA, 94304, US

(21) Appl. No.: 10/231,590

(22) Filed: Aug. 30, 2002

(30) Foreign Application Priority Data
Aug. 31, 2001 (KR) 2001-0053497

(51) Int. Cl. G01M 19/00

(52) U.S. Cl. 73/118.1

(57) ABSTRACT

Valve overlap of an engine having an intake cam and exhaust cam is measured using an apparatus including: a rotating angle detecting unit comprising a first detector for detecting a rotating angle of the intake cam, and a second detector for detecting a rotating angle of the exhaust cam; and a processor for receiving detected signals from the rotating angle detecting unit and for calculating valve overlap of the engine based on the received signals.

### FIELD OF THE INVENTION

The present invention relates to method and apparatus for measuring valve overlap of an engine.

### BACKGROUND OF THE INVENTION

Engine performance depends on factors such as operating time of intake/exhaust valves and valve-lift thereof. In order to improve performance at a low revolution speed range, combustion efficiency is usually enhanced by reducing the valve lift of intake valves, and consequently by elevating the flow speed of the air-fuel mixture drawn into the combustion chamber. In order to improve performance at a high revolution speed range, the amount of air-fuel mixture drawn into the combustion chamber is usually increased by increasing the valve-lift and the duration during which the valves are open. Thus, the most appropriate valve timing depends on engine operating conditions such as engine speed and engine load. Recently, a variable valve timing engine has been introduced wherein valve timing can be varied as engine operating conditions are varied.

Valve overlap denotes a time period where both an intake valve and an exhaust valve are open. This occurs at the end of an exhaust stroke or a beginning of an intake stroke of a piston. Therefore, valve overlap in a variable valve timing engine varies according to engine operating conditions and must be measured at each engine operating condition in order to determine whether the engine works properly as designed.

However, there have only been manual measuring techniques such that intake/exhaust camshafts installed in an engine are operated and valve overlap of the engine is visually checked, at best, using a simple measuring tool. Therefore, it is very difficult and time consuming to measure valve overlap at all the necessary engine operating conditions according to the prior art.

### SUMMARY OF THE INVENTION

The present invention provides a method and apparatus for measuring valve overlap of an engine, and displaying values of valve overlap measured at various engine operating conditions. An exemplary apparatus for measuring valve overlap of an engine having an intake cam according to an embodiment of the present invention includes a rotating angle detecting unit and a processor. The rotating angle detecting unit comprises a first detector for detecting a rotating angle of the intake cam, and a second detector for detecting a rotating angle of the exhaust cam. The processor receives detected signals from the rotating angle detecting unit and calculates valve overlap of the engine based on the received signals.

In a further embodiment, an input device for inputting engine operating conditions is further included such that the processor calculates the valve overlap of the engine at input engine operating conditions.

In a further preferred embodiment, an amplifier unit for amplifying signals of the rotating angle detecting unit and an AD/DA converter for converting amplified signals of the amplifier unit to digital signals are included such that the processor receives the detected signals from the rotating angle detecting unit via the AD/DA converter.

In another embodiment, a first height difference is formed at a position corresponding to a beginning of a lobe of the intake cam, the position being on a circumference of a camshaft having the intake cam formed thereon. A second height difference is formed at a position corresponding to an ending of a lobe of the exhaust cam, the position being on a circumference of a camshaft having the exhaust cam formed thereon. The rotating angle detecting unit detects the first and second height differences.

An exemplary method for measuring valve overlap of an engine having an intake cam and an exhaust cam includes: detecting a rotating angle of the intake cam using a first detector; detecting a rotating angle of the exhaust cam using a second detector; and calculating the valve overlap of the engine using a processor based on the rotating angle of the intake cam and the rotating angle of the exhaust cam.

A further preferred embodiment also includes setting engine operating conditions and operating the engine at the engine operating conditions such that the valve overlap is calculated when the engine operates at the engine operating conditions. In a further preferred embodiment, storing the calculated valve overlap and displaying a plurality of valve overlaps as a map based on the stored valve overlaps are further included. In yet another preferred embodiment, the map is displayed with a plurality of contour lines.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of an apparatus for measuring valve overlap of an engine according to a preferred embodiment of the present invention;

FIGS. 2a and 2b, respectively, are sections of an exhaust camshaft and an intake camshaft fashioned for measuring valve overlap of an engine according to a preferred embodiment of the present invention;

FIG. 3 is a flowchart showing a method for measuring valve overlap of an engine according to a preferred embodiment of the present invention;

FIG. 4 illustrates exemplary signals detected by an apparatus for measuring valve overlap of an engine according to a preferred embodiment of the present invention; and

FIG. 5 is an exemplary graph showing valve overlap values measured according to a preferred embodiment of the present invention.

### DETAILED DESCRIPTION OF THE PREFERRED EMBODIMENTS

A preferred embodiment of the present invention will hereinafter be described in detail with reference to the accompanying drawings.

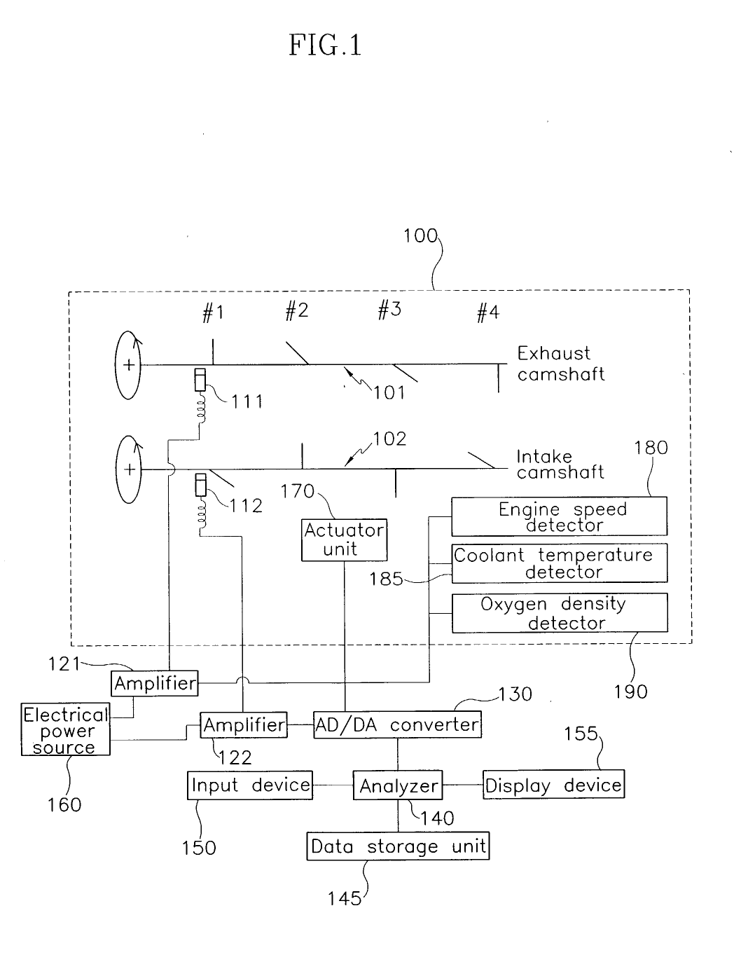

As shown in FIG. 1, an apparatus for measuring valve overlap of an engine 100 according to a preferred embodiment of the present invention includes sensors 111 and 112, amplifiers 121 and 122, an AD/DA converter 130, an analyzer 140, a data storage unit 145, an electrical power source 160, an input device 150, and a display device 155. The sensors 111 and 112 may be realized as proximity sensors or magnetic pick-up sensors such that a protrusion or an indent formed on the circumference of camshafts 101 and 102 can be detected. The amplifiers 121 and 122 amplify signals respectively input from sensors 111 and 112 to a predetermined level. The AD/DA converter 130 converts analog signals received from the amplifiers 121 and 122 to digital signals that the analyzer 140 can receive.

The analyzer 140 processes phase (or angle) data of the exhaust and intake camshafts 101 and 102. The processed data is subsequently stored in data storage unit 145 or displayed on display device 155. The analyzer 140 may be realized by one or more processors activated by predetermined software. The predetermined software can be programmed to perform each step that must be performed at the analyzer 140 in all steps of the method for measuring valve overlap of the engine 100 according to a preferred embodiment of the present invention.

The data storage unit 145 may be realized by any kind of data storage device, for example, a hard disk or RAM (Random Access Memory). The display device 155 may be realized by any kind of display device that can display output signals received from the analyzer 140, for example, a CRT or LCD. The input device 150 may be realized by any kind of device that can input predetermined types of data, such as a keyboard.

Referring to FIG. 1, an experiment for measuring valve overlap of the engine 100 is performed having exhaust and intake camshafts 101 and 102 installed in the engine 100. The engine 100 is provided with an engine speed detector 180, a coolant temperature detector 185, and an oxygen density detector 190 for detecting a density of remnant oxygen in exhaust gas. The engine 100 is also provided with an actuator unit 170 for varying engine operating conditions. In this preferred embodiment, the engine operating conditions are set according to engine speed and engine load. The actuator unit 170 may be selected by a person skilled in the art, for example, a throttle valve.

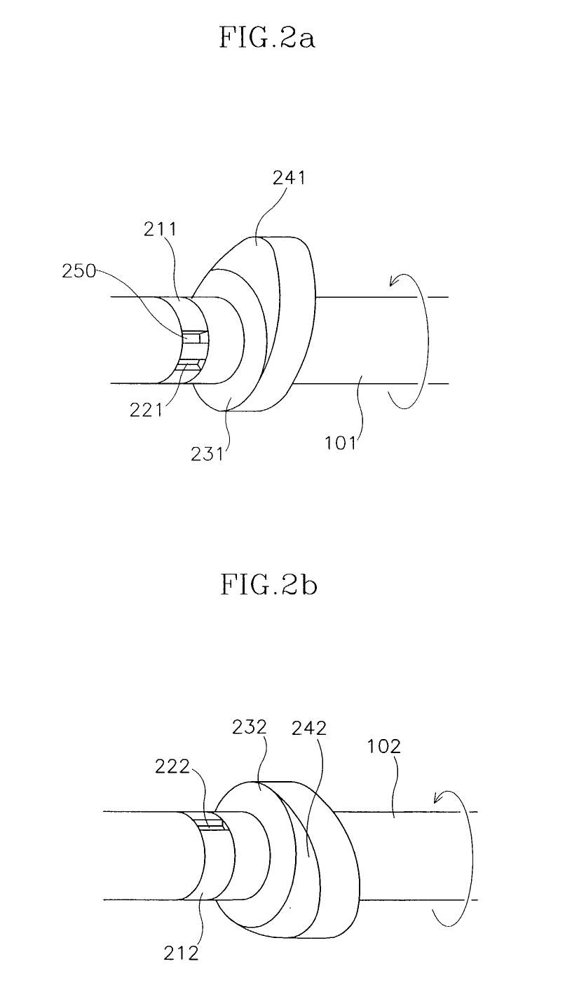

FIGS. 2a and 2b respectively show sections of an exhaust camshaft 101 and an intake camshaft 102 fashioned for measuring valve overlap of the engine 100 according to a preferred embodiment of the present invention. As shown in FIG. 2a, the exhaust camshaft 101 is fashioned such that a circumference 211 of the exhaust camshaft 101 is a full circle at a particular location, and a slot 221 is formed at the circular circumference 211. The slot 221 is formed at a position corresponding to an end of a lobe 241 of exhaust cam 231.

As shown in FIG. 2b, the intake camshaft 102 is fashioned such that a circumference 212 of the intake camshaft 102 is a full circle at a particular location, and a slot 222 is formed at the circular circumference 212. The slot 222 is formed at a position corresponding to a beginning of a lobe 242 of an intake cam 232.

Furthermore, a slot 250, for detecting TDC (Top Dead Center), is formed at either or both of the exhaust and intake camshafts 101 and 102. In this preferred embodiment, the slot for detecting TDC is formed at the exhaust camshaft 101, as shown in FIG. 2a.

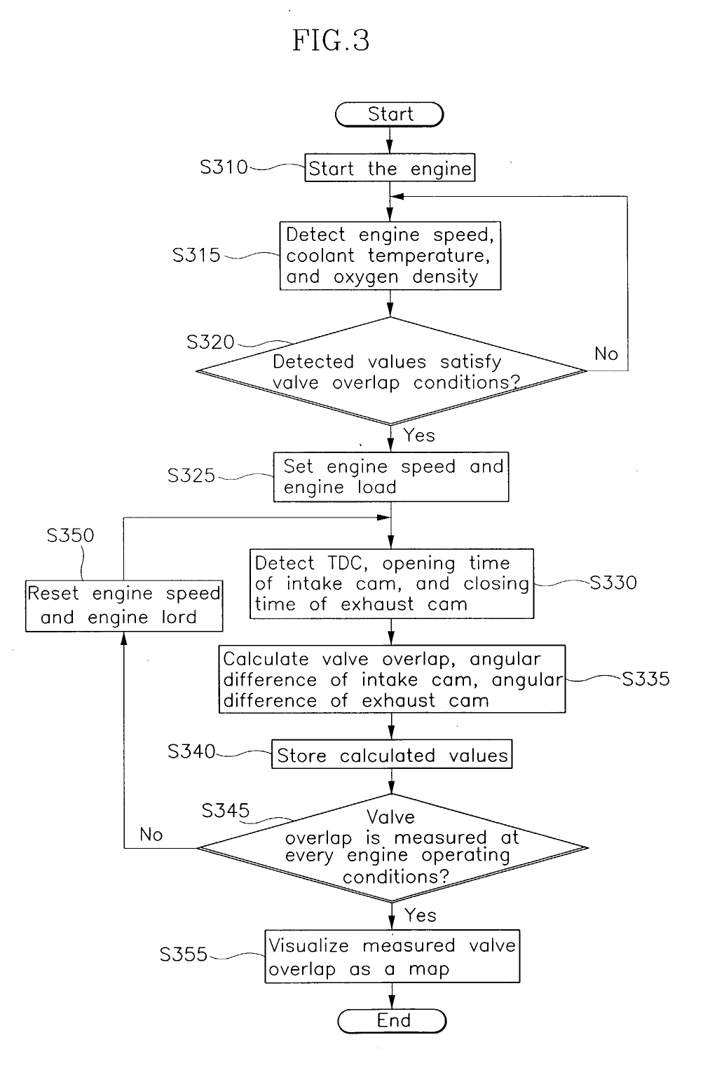

A method for measuring valve overlap of an engine according to a preferred embodiment of the present invention is hereinafter described in detail with reference to FIG. 3. Exhaust and intake camshafts 101 and 102, having been fashioned as described with reference to FIGS. 2a and 2b, are installed in the engine 100 and the engine 100 is started at step S310.

When the engine 100 is started, the analyzer detects, at step S315, the engine speed by way of the engine speed detector 180. Coolant temperature is detected by way of the coolant temperature detector 185. An output signal (usually referred to as a λ-signal) of the oxygen density detector 190 is also received by the analyzer. Subsequently at step S320, the analyzer determines whether the detected values satisfy predetermined overlap measuring conditions.

The valve overlap measuring conditions may be preset as any preferable conditions by a person skilled in the art. When the detected values satisfy the predetermined overlap measuring conditions, the analyzer 140 measures valve overlap at particular engine operating conditions.

Firstly, the analyzer 140 sets the engine operating conditions, for example, engine speed and engine load, and operates the engine 100 according to the engine operating conditions at step S325.

The engine operating conditions may be manually set from the input device 150. The engine operating conditions may be set as, in addition to particular values, particular ranges of engine speed and engine load such that valve overlap may be measured at each of the engine operating conditions in the set ranges.

When the engine 100 is operated according to the engine operating conditions at step S325, the analyzer 140 detects TDC, opening time of the intake cam 232, and closing time of the exhaust cam 231 at step S330 based on signals from the sensors 111 and 112. The sensors 111 and 112 generate signals corresponding to slots 221, 250, and 222, and the amplifiers 121 and 122 respectively amplify the signals of the sensors 111 and 112. The amplified analog signals are converted to digital signals at the AD/DA converter 130, and are transmitted to the analyzer 140.

Subsequently, at step S335, the analyzer 140 calculates valve overlap based on a time period from the opening time of the intake cam 232 to the closing time of the exhaust cam 231, angular difference between the opening time of the intake cam 232 and TDC, and angular difference between the closing time of the exhaust cam 231 and TDC. Therefore, the time difference between occurrences of the closing and opening signals correspond to the valve overlap.

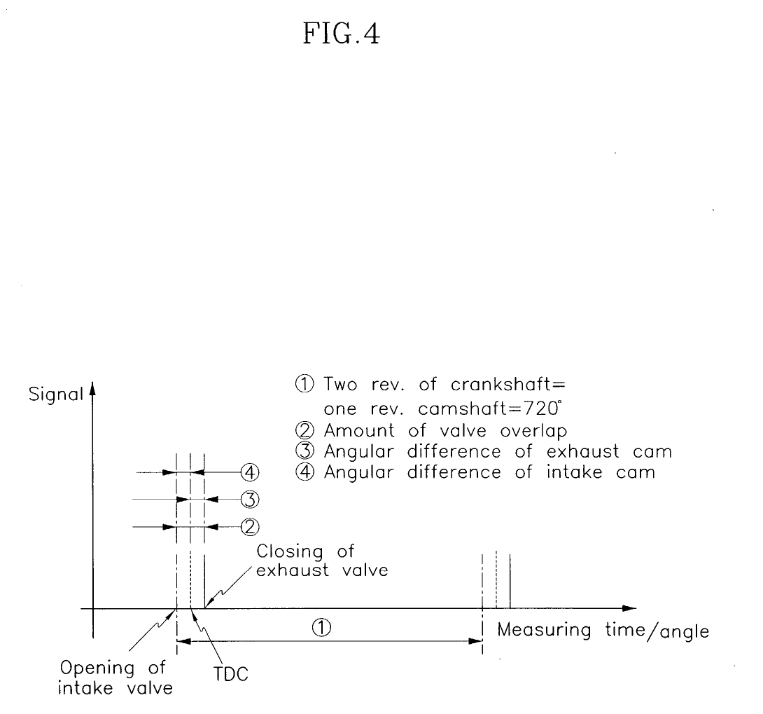

The opening signal of the intake cam and the closing signal of the exhaust cam received at the analyzer 140 are repeated for each period (that is, a period that corresponds to one rotation of the camshaft), as shown in FIG. 4. Preferably, a normalized valve overlap is calculated by dividing the calculated valve overlap by the period such that the calculated valve overlap is free from error caused by exterior factors such as sampling time and engine speed.

When the measured values including the valve overlap are calculated at step S335, the analyzer 140 stores the measured values in the data storage unit 145 at step S340. Subsequently, at step S345, the analyzer 140 determines whether valve overlap is measured at every engine operating condition set at step S325.

When valve overlap is not measured at every engine operating condition, the analyzer 140 resets the engine operating conditions (engine speed and engine load) at step S350 to the conditions at which the valve overlap is not yet measured, and restarts the step S330.

When valve overlap is measured at every engine operating condition, the analyzer 140 retrieves valve overlaps measured at a variety of engine operating conditions and displays the retrieved data as a visual map at the display device 155 at step S355.

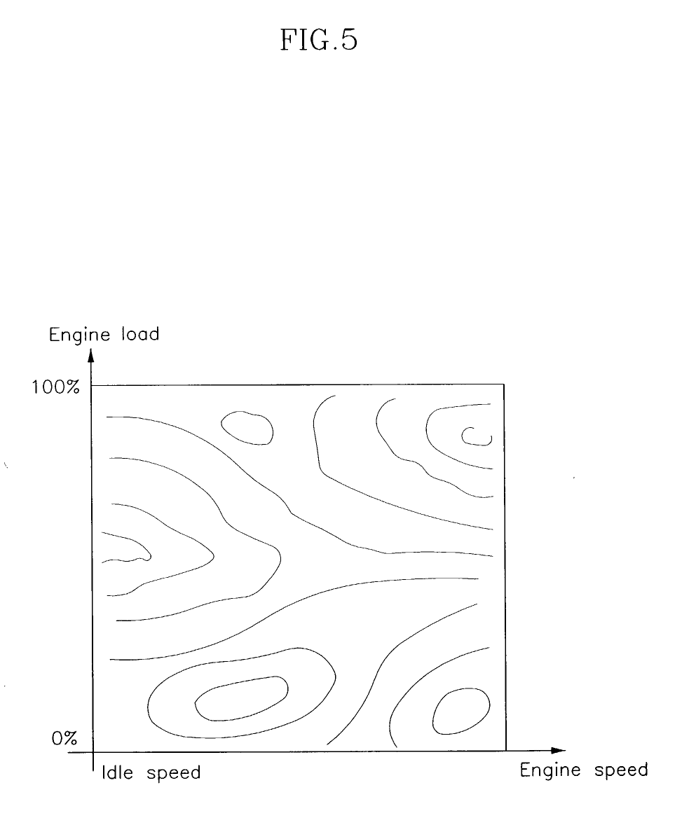

As shown in FIG. 5, the engine operating conditions are set according to engine speed and engine load. A value of the valve overlap may be scaled by a color (or by a grayscale if the display device 155 does not support colors). FIG. 5 shows contour lines that are introduced in order to distinguish a plurality of valve overlap ranges.

As described above, according to a preferred embodiment of the present invention, reliability of experimentally acquired valve overlap values is achieved because the experiment for measuring valve overlap of an engine is performed with an engine having its camshafts installed therein. Furthermore, a plurality of valve overlaps are measured with ease at various engine operating conditions, and the measured data can be easily compared with designed values because they are visualized as a map, wherein the ease of evaluation is increased by contour lines.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for measuring valve overlap of an engine having an intake cam and an exhaust cam, the apparatus comprising:
a rotating angle detecting unit comprising a first detector for detecting a rotating angle of the intake cam, and a second detector for detecting a rotating angle of the exhaust cam; and
a processor receiving detected signals from the rotating angle detecting unit and programmed to calculate valve overlap of the engine based on the received signals.

2. The apparatus of claim 1, further comprising an input device for inputting engine operating conditions, wherein the processor calculates the valve overlap of the engine at input engine operating conditions.

3. The apparatus of claim 2, further comprising an amplifier unit for amplifying signals of the rotating angle detecting unit, and an AD/DA converter for converting amplified signals of the amplifier unit to digital signals, wherein the processor receives the detected signals from the rotating angle detecting unit via the AD/DA converter.

4. The apparatus of claim 1, wherein:
a first height difference is formed at a position corresponding to a beginning of a lobe of the intake cam, the position being on a circumference of a camshaft having the intake cam formed thereon;
a second height difference is formed at a position corresponding to an ending of a lobe of the exhaust cam, the position being on a circumference of a camshaft having the exhaust cam formed thereon; and
the rotating angle detecting unit detects the first and second height differences.

5. A method for measuring valve overlap of an engine having an intake cam and an exhaust cam, the method comprising:
detecting a rotating angle of the intake cam using a first detector;
detecting a rotating angle of the exhaust cam using a second detector; and
calculating the valve overlap of the engine using a processor based on the rotating angle of the intake cam and the rotating angle of the exhaust cam.

6. The method of claim 5, further comprising setting engine operating conditions and operating the engine at the engine operating conditions, wherein the calculating the valve overlap of the engine calculates the valve overlap when the engine operates at the engine operating conditions.

7. The method of claim 6, further comprising:
storing the calculated valve overlap; and
displaying a plurality of valve overlaps as a map based on the stored valve overlaps.

8. The method of claim 7, wherein the map is displayed with a plurality of contour lines.
